(19) United States
(12) Patent Application Publication
(10) Pub. No.: US 2025/0322024 A1
(43) Pub. Date: Oct. 16, 2025

(54) METHODS AND SYSTEMS FOR COOKIE PROCESSING OPTIMIZATION

(71) Applicant: Shopify Inc., Ottawa (CA)

(72) Inventors: Jon French, Fort Collins, CO (US); Samuel Jones, Cherry Hill, NJ (US); Colin Bendell, Ottawa (CA)

(21) Appl. No.: 19/056,968

(22) Filed: Feb. 19, 2025

Related U.S. Application Data
(63) Continuation-in-part of application No. 18/893,296, filed on Sep. 23, 2024.
(60) Provisional application No. 63/632,306, filed on Apr. 10, 2024.

(51) Int. Cl. G06F 16/957; G06F 21/60

(52) U.S. Cl. CPC G06F 16/9574; G06F 21/602

(57) ABSTRACT

A computing device configured to receive a request from a web browser, the request including a received cookie having an unencrypted portion and an encrypted portion; and determine, from the unencrypted portion of the received cookie, whether a freshness timer has expired. When the freshness timer has expired, the computing device is configured to send a request to a network server for an updated encrypted portion, receive the updated encrypted portion, reset the freshness timer, create a revised cookie with the updated encrypted portion and reset freshness timer, and send the revised cookie to the web browser. When the freshness timer has not expired, the computing device is configured to create the revised cookie, the revised cookie using the unencrypted portion and freshness timer from the received cookie; and send the revised cookie to the web browser.

### RELATED APPLICATIONS

The present disclosure claims priority to U.S. Provisional Application No. 63/632,306, filed Apr. 10, 2024, entitled “METHODS AND SYSTEMS FOR SPILLOVER FROM COOKIE TO DATABASE”; and is further a continuation-in-part of U.S. application Ser. No. 18/893,296, filed Sep. 23, 2024, and entitled “METHODS AND SYSTEMS FOR SPILLOVER FROM COOKIE TO DATABASE”, the entire contents of both of which are incorporated herein by reference.

### FIELD OF THE DISCLOSURE

The present disclosure relates to web domains, and in particular relates to cookies for web domains.

### BACKGROUND

A browser cookie, often simply referred to as a “cookie,” is a small piece of data that a website or domain stores on a user's computing device, typically through the web browser. Cookies capture state and may be used to store information about a user, their preferences, and their activities on the website. This data is stored by the user's browser and sent back to the web server each time the browser requests a page or other information from the server.

### SUMMARY

In embodiments of the present disclosure, a cookie may require a time-to-live threshold for its payload that may differ from the time-to-live for the cookie itself. This may be important in cases where the system does not want to update the payload with every request, because this may be too resource intensive, but wants to update the payload more often than the cookie expiration time. For example, a cookie which holds user preference data may have a relatively long expiration so as to provide user experience continuity over that period. However, this expiration may be too long to wait to update the cookie payload, and thus the embodiments of the present disclosure provide for a separate freshness threshold for such payload.

In one aspect, a method at a computing device may be provided. The method may include receiving a request from a web browser, the request including a received cookie having an unencrypted portion and an encrypted portion. The method may further include determining, from the unencrypted portion of the received cookie, that a freshness timer has not expired, and based on the determining, creating a revised cookie, the revised cookie using the unencrypted portion and freshness timer from the received cookie. The method may further include sending the revised cookie to the web browser.

In some embodiments, the method may further include receiving a second request from the web browser, the second request including a second received cookie having a second received cookie unencrypted portion and a second received cookie encrypted portion and determining, from the unencrypted portion of the second received cookie, that the freshness timer has expired. The method may further include sending a request to a network server for an updated encrypted portion, receiving the updated encrypted portion, and resetting the freshness timer. The method may further include creating a second revised cookie with the updated encrypted portion and reset freshness timer and sending the second revised cookie to the web browser.

In some embodiments, the revised cookie may include an updated expiration timer that differs from the expiration timer of the received cookie.

In some embodiments, the freshness timer may be shorter than an expiration timer for any of the received cookie and the revised cookie.

In some embodiments, the method may further include storing at the computing device the encrypted portion of the received cookie in unencrypted form.

In some embodiments, the received cookie may include an identification number in the unencrypted portion, and wherein the revised cookie may use the same identification number in its unencrypted portion.

In some embodiments, the received cookie may include a decryption key identifier in the unencrypted portion, and wherein the request to the network server may include the decryption key identifier.

In some embodiments, the encrypted portion of the received cookie may include user profile information.

In a further aspect, a computing device having a processor and a communication subsystem may be provided. The computing device may be configured to receive a request from a web browser, the request including a received cookie having an unencrypted portion and an encrypted portion, and determine, from the unencrypted portion of the received cookie, whether a freshness timer has expired. The computing device may further be configured to, when the freshness timer has expired, send a request to a network server for an updated encrypted portion, receive the updated encrypted portion, reset the freshness timer, create a revised cookie with the updated encrypted portion and reset freshness timer, and send the revised cookie to the web browser. The computing device may further be configured to, when the freshness timer has not expired, create the revised cookie, the revised cookie using the unencrypted portion and freshness timer from the received cookie, and send the revised cookie to the web browser.

In some embodiments, the revised cookie using the unencrypted portion and freshness timer from the received cookie may include an updated expiration timer that differs from the expiration timer of the received cookie.

In some embodiments, the freshness timer may be shorter than an expiration timer in any of the received and revised cookies.

In some embodiments, the computing device may include a memory for storing the encrypted portion of the received cookie in unencrypted form.

In some embodiments, the received cookie may include an identification number in the unencrypted portion, and wherein the revised cookie may use the same identification number in its unencrypted portions.

In some embodiments, the received cookie may include a decryption key identifier in the unencrypted portion, and wherein the request to the network server may include the decryption key identifier.

In some embodiments, the encrypted portion of the received or revised cookie may include user profile information.

In a further aspect, a computer readable medium for storing instruction code may be provided. The instruction code, when executed by a processor of a computing device, may cause the computing device to receive a request from a web browser, the request including a received cookie having an unencrypted portion and an encrypted portion and determine, from the unencrypted portion of the received cookie, whether a freshness timer has expired. The instruction code may further cause the computing device to, when the freshness timer has expired, send a request to a network server for an updated encrypted portion, receive the updated encrypted portion, reset the freshness timer, create a revised cookie with the updated encrypted portion and reset freshness timer, and send the revised cookie to the web browser. The instruction code may further cause the computing device to, when the freshness timer has not expired, create the revised cookie, the revised cookie using the unencrypted portion and freshness timer from the received cookie; and send the revised cookie to the web browser.

In some embodiments, the revised cookie using the unencrypted portion and freshness timer from the received cookie may include an updated expiration timer that differs from the expiration timer of the received cookie.

In some embodiments, the freshness timer may be shorter than an expiration timer in any of the received and revised cookies.

In some embodiments, the computing device may include a memory for storing the encrypted portion of the received cookie in unencrypted form.

In some embodiments, the received cookie may include an identification number in the unencrypted portion, and wherein the revised cookie may use the same identification number in its unencrypted portions.

### BRIEF DESCRIPTION OF THE DRAWINGS

The present disclosure will be better understood with reference to the drawings, in which:

FIG. 1 is a block diagram showing an example browser cookie, where a portion of the browser cookie is encrypted.

FIG. 2 is a block diagram showing an example system in which browser cookies may be used.

FIG. 3 is a dataflow diagram showing the creation of revised cookies depending on whether a freshness timer in a received cookie has expired.

FIG. 4 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

HTTP (Hypertext Transfer Protocol) is considered stateless, meaning that each request from a client to a server is independent and unrelated to any previous requests. This statelessness implies that the server does not retain any information about past interactions with a particular client. Once a request is made and a response is sent back, the connection is effectively terminated, and the server does not maintain any knowledge of the client's previous requests or session data. This design simplifies the implementation and scalability of web servers since they do not need to store extensive amounts of information about each client session.

Browser cookies were introduced as a solution to the statelessness of HTTP, allowing websites to maintain some level of state or continuity between requests. Cookies are pieces of data sent from a website and stored in a user's web browser while the user is browsing. They contain information such as user preferences, session identifiers, or other data relevant to the website's functionality. When the user makes subsequent requests to the same website, the browser sends the stored cookies along with the request, enabling the server to recognize the user and maintain continuity across their interactions. Cookies thus provide a way for websites to associate individual requests with user sessions, personalize content, and maintain stateful interactions within the stateless environment of HTTP.

Cookies are relatively small data structures stored on a computer that are transmitted to webservers along with HTTP requests. As provided in U.S. Application No. 63/632,306 and/or U.S. application Ser. No. 18/893,296, the contents of which are incorporated by reference, a computing device may encode data in a cookie such that there is an unencrypted header and encrypted payload. The header contains a pointer or identifier indicative of a decryption key (or key pair), and the payload is encrypted/decrypted by that key (or key pair). When a webserver receives such a cookie from a user, it will decrypt the contents and use the information when generating a response to the HTTP request.

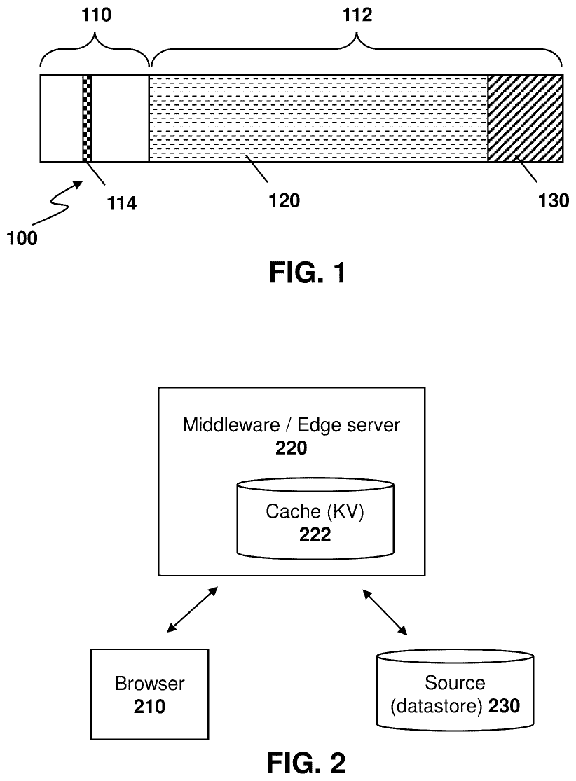

Specifically, in some cases parts of the cookie may be encrypted. Reference is now made to FIG. 1, which shows a browser cookie 100.

In the embodiment of FIG. 1, an unencrypted preamble 110 within browser cookie 100 allows retrieval of a decryption key at the server. Such information may include a key identifier in some cases. In some cases, the key identifier may include a location or “region” identifier for the key store. Such a key identifier may provide enough information that the server receiving the cookie can find the correct decryption key. Specifically, keys may rotate frequently, and thus the key identifier may identify which key was used at a specific time in the past to allow the browser cookie 100 to be decrypted. This may be useful in situations where a site visitor may have long periods of inactivity, but in which re-authentication may not be possible, such as an electronic commerce application. Because information in the cookie may be sensitive, the keys used for encryption may be changed frequently, but the information may still need to be decrypted after a long period of inactivity. Thus, the key identifier could be used to find the correct decryption key.

In some cases, the key identifier may be a public key significant bit or bits.

Further, in some cases, the server doing the decrypting may be different from the web server, where the web server may forward the encrypted browser cookie 100 to the decryption server for decryption.

In some cases, the unencrypted preamble 110 may store a compression algorithm identifier to identify how portions of the message are compressed.

In some cases, the unencrypted preamble 110 may have a timestamp the cookie was created at for easy tracking and sorting. In the case of rotating encryption/decryption keys, the timestamp may be used to determine which key was valid at the time of the cookie's creation.

In some cases, as described below, the unencrypted preamble 110 may contain a “freshness” timestamp 114, indicating when the payload for the cookie was last updated.

Specifically, in some cases the encrypted payload 112 of the cookie may be relatively static, and may change very little. In one case, an example payload in the encrypted portion of the cookie may be user profile information. It may therefore be computationally inefficient to send requests to a datastore, such as a Key Value server, constantly. In this regard, in accordance with embodiments of the present disclosure, the unencrypted portion of the cookie may contain the freshness timestamp 114. Such timestamp is in addition to the typical cookie expiration timestamp provided by the cookie metadata. The freshness timestamp 114 may be used by a middleware server to determine whether the cookie payload needs to be updated, or whether the current cookie payload is sufficient.

In some cases, metadata on the cookie could form part of the unencrypted preamble 110. For example, such information may include any information or subset of information typically found in a cookie, including but not limited to a name for the cookie; expiration date or time, or a maximum age, indicating when the cookie should be deleted by the browser; a domain or subdomain that the cookie is valid for; a path for which the cookie is valid; a secure flag to indicate that the cookie can only be transmitted on HTTP Secure (HTTPS) connections; an Http-Only Flag to prevent access to the cookie at the client and therefore mitigating cross site scripting attacks; a freshness timestamp; and a Same-Site Attribute, which controls when cookies are sent with cross-origin requests. Such information may be used by the web browser to determine when the cookie can be sent, and thus may form part of the unencrypted preamble in some cases.

Other information could also form part of the unencrypted preamble 110.

Encrypted cookie portion 112 may contain session cookie information 120. Session cookie information 120 could include any information or subset of information typically found in a cookie, and in particular the value field, which includes the information stored in the cookie.

In some cases, the encrypted cookie portion 112 of browser cookie 100 may have User Agent (UA) and a client fingerprint, which may be used for cross-site-request-forgery (CSRF) detection.

The value within the session cookie information can store various data, and can include text, images, or multimedia, and can thus grow to become large. In this regard, in some cases, an overflow indication 130 may be added to the encrypted cookie portion 112 of browser cookie 100 to indicate that additional data for the cookie is stored in a network database. The overflow indication 130 may further include a region identifier to show the region or location of a datastore for storing the overflow information. However, such overflow indication 130 is optional, and may be excluded in some cases.

The schema for browser cookie 100 may be enforced using various data formats. One non-limiting example is Protobuf, which is an open source data format used to serialize structured data.

The cookie 100 from the embodiment of FIG. 1 may be used in a web browsing system. For example, reference is now made to FIG. 2, which shows a simplified system that may be used with the embodiments of the present disclosure.

Specifically, in the example of FIG. 2, a browser 210 may be an application located within a computing system. For example, the browser may be on a personal computer, desktop computer, laptop, tablet, mobile device, among other options.

The browser may communicate with a web server, shown in the example of FIG. 2 as a middleware or edge server 220. Depending on the location of the browser 210, on web traffic, on routing patterns or algorithms, or on other factors, different middleware or edge servers 220 may service browser 210 from time to time.

In the example of FIG. 2, the middleware or edge server 220 may include a cache 222, which may store keys used to decrypt an encrypted cookie 100. However, if cache 222 does not have the requested information, in some embodiments the cache 222 may perform a lookup from a datastore 230, where in some cases datastore 230 may be a global key/value store. Cache 222 may, in some embodiments, be optional.

In some cases, cache 222 could further store unencrypted versions of encrypted payloads.

Thus, in some embodiments, the middleware or edge server 220 may receive an encrypted cookie and may extract, from the unencrypted header, the location of the key value store, which may for example be datastore 230. For example, the unencrypted header may in some embodiments contain two values. A “public key significant bit” may reference a symmetric key, which in some cases may be looked up as a secret environment variable rather than from a key/value server. A “Region identifier” may reference a storage server where the expanded session resides.

The middleware or edge server 220 may then provide a request to the datastore 230 to obtain the key to decrypt the cookie in some cases. In some cases, the middleware or edge server 220 may provide the encrypted cookie or payload from the cookie to the datastore 230 and the datastore 230 may then provide a copy of the unencrypted payload back to the middleware or edge server 220. In some cases, the middleware or edge server 220 may provide the encrypted cookie or encrypted cookie payload to datastore 230, which may then decrypt the payload, modify it as necessary, re-encrypt it, and provide the new payload back to the middleware or edge server 220. Other options for communication between the middleware or edge server 220 and datastore 230 are possible.

Thus, in some embodiments, a web server such as a middleware or edge server 220, may receive a message from a browser 210, such as an HTTP GET, with a cookie attached. The cookie, as described above, may have an unencrypted portion and an encrypted portion. The middleware or edge server 220 may send metadata from the unencrypted portion, optionally along with the encrypted portion, to a datastore 230, for example using cache 222, which may return a new encrypted cookie payload. The middleware server may then provide, in a response to the browser, a SET Cookie message with the new cookie.

As will be appreciated by those in the art, communication between servers, decrypting and encrypting, among other operations, can be computationally demanding when scaled to a large system with many cookies, and may lead to delays in communication.

Further, in some cases the encrypted payload of the cookie may be relatively static, and may change very little. One example payload in the encrypted portion 112 of the cookie 100 may be user profile information. It may therefore be computationally inefficient to send such requests to the cache 222 and/or to datastore 230 constantly.

In this regard, in accordance with embodiments of the present disclosure, the unencrypted portion 110 of the cookie may contain the freshness timestamp 114. Such timestamp is in addition to the typical cookie expiration timestamp provided by the cookie metadata. The freshness timestamp may be used by the middleware or edge server 220 to determine whether the cookie payload needs to be updated, or whether the current cookie payload is sufficiently fresh.

Specifically, in accordance with embodiments of the present disclosure, a middleware server receives an HTTP GET message with a cookie. The middleware server may look for the freshness timestamp in the unencrypted portion of the cookie.

When the freshness timestamp is within a predetermined time from the current time (for example 1 hour), then the middleware server may compose and set a cookie without a request to a datastore such as a key value server. In this case, the encrypted portion from the cookie that was received at the middleware server, or a cookie for the session stored in the cache at the middleware server, may become the encrypted portion for the new cookie. Further, the freshness timestamp in the unencrypted portion of the cookie will remain the same. However, the cookie expiration time may be updated, for example to allow the cookie to expire in a predetermined interval. Such new or revised cookie may be sent to the web browser in an HTTP SET Cookie message.

Conversely, when the freshness timestamp is older than the current time minus a predetermined threshold (i.e. the freshness timer has expired), then the contents of the encrypted portion may need to be refreshed. In this case, the middleware server may make a request to the datastore. In some cases, such a request can include the encrypted payload or the entire cookie. However, in some cases the request may simply include an identifier which may be associated with a copy of the cookie stored at the key value server. In some cases, the decryption/encryption may be done by the middleware server, rather than at a key value server. Other options are possible. The datastore may, in some cases, decrypt the encrypted portion. The datastore may update the encrypted portion of the cookie and re-encrypt it. The datastore, if it comprises the key value server, may then send the updated cookie (or the updated cookie payload) to the middleware server.

The middleware server may then create a cookie by using the encrypted payload, adding a new freshness timestamp to the cookie, and adding a new expiration time for the cookie itself. This new (revised) cookie may be sent to the web browser in an HTTP SET Cookie message.

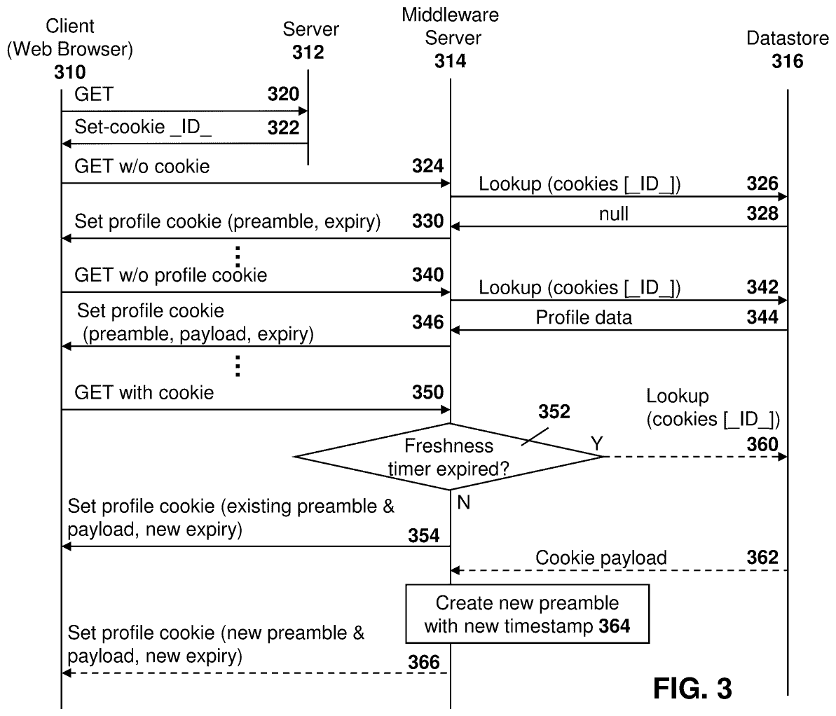

Reference is now made to FIG. 3. In the example of FIG. 3, a client 310 such as a web browser, communicates with a server 312 to obtain identification for the client 310. Further, a middleware server 314 and a datastore 316 may form part of the system.

In particular, a client 310 may login or otherwise seek to obtain an identification cookie by sending a GET message 320 to server 312, and receive a SET cookie message 322 in response, the cookie including an identifier for the client 310. In some cases, server 312 may be independent of middleware server 314 and datastore 316. In some cases, server 312 may be part of one or both of middleware server 314 and/or datastore 316.

Subsequently, for example on a page load, client 310 may communicate with middleware server 314. The first time the client does this, only the identifier cookie from message 322 and a potential, unnamed cookie that has not yet been set exist, and thus a GET message 324, without a session or profile cookie, may be sent to middleware server 314.

Middleware server 314, upon receiving GET message 324, may perform a lookup from the datastore 316, shown with message 326, for example by providing an identifier from the identifier cookie of message 322 to datastore 316.

Datastore 316, upon receiving message 326, may search for any data used to construct a cookie stored therein, and identified with the identifier provided in the lookup message 326. In this case, no previous data (or profile cookies) are stored or have been set, and the datastore 316 returns a null message 328 to middleware server 314.

The middleware server 314 may then create a profile cookie having an unencrypted preamble with payload freshness timestamp, no payload, and cookie expiration time. For example, the payload freshness timestamp may be 1 hour and the expiration time may be one day, one week, one month, among other options. This profile cookie is then returned to the client 310 in message 330.

Subsequently (not shown) a user may perform more actions, and the system may build their profile, and post profile data to the datastore 316 for the user ID.

However, in the example of FIG. 3, the time period for expiration for the profile cookie may pass (for example one week). In this case, a client 310, on page load, may send another GET message 340 to middleware server 314. In this case, since the previous profile cookie has expired, the GET message 340 contains no profile cookie.

In this case, middleware server 314 sends a lookup message with the client identifier to datastore 316, shown with lookup message 342. Since the datastore stored profile data previously, it may return message 344 with profile data. In some cases, such profile data may be a cookie payload. The cookie payload may be encrypted in some embodiments. Message 344 may therefore in some cases contain a decryption key identifier in an unencrypted format.

Further, in some cases, message 344 may contain an unencrypted payload that can be stored in a cache at middleware server 314.

While the embodiment of FIG. 3 shows messages 342 and 344 resulting from a GET message without a cookie, in practice messages 342 and 344 could be used anytime there is profile data used to construct the cookie present in the datastore 316. This may happen either on the first request for a newly identified user, or the first request after the browser cookie has expired. Thus, in some cases message 344 may be sent in response to message 326, for example, when datastore 316 contains profile data. Other options are possible.

Middleware server 314 may then create a profile cookie in some embodiments. The profile cookie could include an unencrypted preamble and an encrypted payload. The encrypted payload would be the payload received from the datastore 316 in message 344. The unencrypted payload could include various metadata and information, including the decryption key identifier in some cases. The unencrypted preamble could further include the client identifier within it.

The unencrypted preamble could further include an expiration time for the profile cookie. Specifically, the expiration time for the profile cookie can be set to a predefined time period after the cookie creation, such as now plus one week for example.

The unencrypted preamble could further include the freshness timer value. For example, the unencrypted preamble could include an indication of when the freshness timer was set. This can be a key value pair where the key indicates that the value is for the freshness time and the value could be the current time or the expiration time, depending how the system is configured.

Thus, for example, the timer could be set in the preamble with a variable such as fresh_time=now. In this case, when a profile cookie is received by the middleware server 314, such server could add a predefined value (e.g. 1 hour) the time after fresh_time and see whether that time has passed. For example, if fresh_time was March 12 at 1:04:45 pm, and the system preconfigured the freshness as being within an hour, then the system could check whether the current time is less than March 12 at 2:04:45 pm.

In other cases, the fresh_time value could be set to the expiration time. Thus when creating the profile cookie, if the time the cookie was created was March 12 at 1:04:4 5pm then the fresh_time value could be set to March 12 at 2:04:45 if one hour is being used as the defined freshness expiry time.

In other cases, the value could be placed in a specific location within the preamble, and thus a key indicating what the value is for may not be needed.

Other options are possible.

The profile cookie could then be sent to client 310 in message 346.

Subsequently, but before the profile cookie expires, the client 310 loads a webpage. This causes a GET message 350 with the profile cookie received at message 346 to be sent to middleware server 314.

Upon receiving message 350, middleware server 314 may, at block 352, check whether the freshness timer in the received cookie has expired.

When it is determined at block 352 that the freshness timer has not expired, then the middleware server 314 may create a new (revised) profile cookie in which the existing encrypted payload is used in the revised cookie. The unencrypted preamble is also largely the same. However, a new expiration time may be used with the cookie, and this may be indicated in the unencrypted preamble in some cases.

The revised cookie may further include the original freshness timer to ensure that the encrypted payload will still expire at the same time.

Further, the decryption key identifier, the client identifier, and other information in the received cookie may be the same in the revised cookie.

The profile cookie may be sent back in a set cookie message 354 to the client 310.

As will be appreciated by those in the art, if the freshness timer has not expired, then no messaging between middleware server 314 and datastore 316 is needed, thereby saving communication time and system resources.

Conversely, if the check at block 352 finds that the freshness timer has expired, then a look up request with the client identifier may be sent to the datastore 316, shown with message 360 in the example of FIG. 3.

Datastore 316 may, on receiving message 360, look up the profile cookie and/or data for the profile cookie for the client identifier and provide a revised encrypted payload back to the middleware server, shown with message 362. Message 362 may in some cases contain a decryption key identifier in an unencrypted format, where such decryption key identifier may be used in locating the decryption key for the encrypted payload.

Further, in some cases, message 362 may contain an unencrypted payload that can be stored in a cache at middleware server 314.

Middleware server 314 may then create a (revised) cookie in some embodiments at block 364. The revised profile cookie could include an unencrypted preamble and an encrypted payload. The encrypted payload would be the payload received from the datastore 316 in message 362. The unencrypted payload could include various metadata and information, including the decryption key identifier in some cases. The unencrypted preamble could further include the client identifier within it.

The unencrypted preamble could further include a new expiration time for the cookie.

The unencrypted preamble could further include a new freshness timer value as the encrypted payload has just changed.

The revised cookie could then be provided back to client 310 in message 366.

In some embodiments, a payload may need to be updated each time the page is loaded. In this case, the freshness timer may be left out. The check at block 352 could determine that no freshness timer exists within the received cookie, and may therefore send message 360 to the datastore 316.

Thus, from the embodiment of FIG. 3, a profile cookie may have a time-to-live threshold for its payload that may differ from the time-to-live for the cookie itself. This may be important in cases where the system does not want to update the payload with every request, because this may be too resource intensive, but wants to update the payload more often than the cookie expiration time. For example, the cookie expiration may cause continuity interruptions in the browsing session of the user, which may not be desirable, and thus the threshold for the life of the cookie itself may be a first value. However, this first value may be too long to wait to update the payload, and thus the embodiments of the present disclosure provide for a separate freshness threshold for such payload.

Thus, from the embodiments of FIGS. 1 to 3, systems and methods are provided where an encrypted payload may not need to be decrypted if a freshness time for the encrypted payload has not yet expired.

Such periodic updating of the payload allows resources to be saved, for example by removing the communications with a server, and the decryption, updating and re-encryption steps, when the payload freshness timer has not expired.

A further benefit to having a static payload for a threshold time is that it may improve a user experience by providing a consistent navigation experience, rather than a disjointed navigation experience that may occur if a profile cookie is constantly updated in website configurations in which the user interface is responsive to data within the cookie payload.

### Computing Device

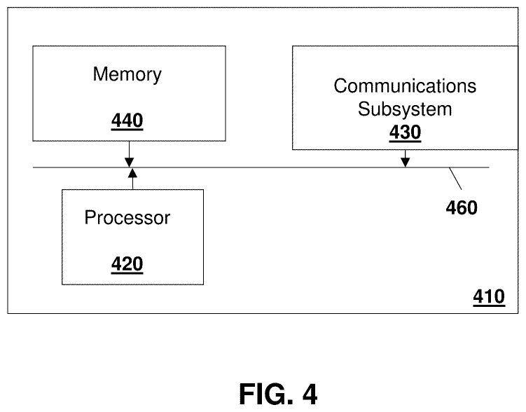

The above-discussed methods are computer-implemented methods and require a computer for their implementation/use. Such computer system could be implemented on any type of, or combination of, network elements or computing devices. This could include web servers; datastores, key value servers, decryption servers; computing devices running browsers; computing devices hosting databases; among others. For example, one simplified computing device that may perform all or parts the embodiments described herein is provided with regard to FIG. 4.

In FIG. 4, computing device 410 includes a processor 420 and a communications subsystem 430, where the processor 420 and communications subsystem 430 cooperate to perform the methods of the embodiments described herein.

The processor 420 is configured to execute programmable logic, which may be stored, along with data, on the computing device 410, and is shown in the example of FIG. 4 as memory 440. The memory 440 can be any tangible, non-transitory computer readable storage medium, such as DRAM, Flash, optical (e.g., Compact Disc (CD), Digital Video Disc (DVD), etc.), magnetic (e.g., tape), flash drive, hard drive, or other memory known in the art. In one embodiment, processor 420 may also be implemented entirely in hardware and not require any stored program to execute logic functions. Memory 440 can store instructions (instruction code), which, when executed by processor 420 cause the computing device 410 to perform the embodiments of the present disclosure. In some cases, memory 440 could be a first computer memory associated with a browser, while when computing device 410 is a server, memory 440 could be a second computer memory at the server used for storing instructions for the configuration of the first computer memory. However, the first memory and second computer memory could in some cases be the same memory. Further, the memory 440, when used for storing browser cookies, may be persisted memory, or may be temporary memory such as Random Access Memory.

Alternatively, or in addition to the memory 440, the computing device 410 may access data or programmable logic from an external storage medium, for example through the communications subsystem 430.

The communications subsystem 430 allows the computing device 410 to communicate with other devices or network elements. In some embodiments, communications subsystem 530 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a Global Positioning System (GPS) receiver, a satellite transceiver, an Infrared Data Association (IrDA) transceiver, among others. As will be appreciated by those in the art, the design of the communications subsystem 430 will depend on the type of communications that the computing device is expected to participate in.

Communications between the various elements of the computing device 410 may be through an internal bus 460 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A method at a computing device, the method comprising:
receiving a request from a web browser, the request including a received cookie having an unencrypted portion and an encrypted portion;
determining, from the unencrypted portion of the received cookie, that a freshness timer has not expired
based on the determining, creating a revised cookie, the revised cookie using the unencrypted portion and freshness timer from the received cookie; and
sending the revised cookie to the web browser.

2. The method of claim 1, further comprising:
receiving a second request from the web browser, the second request including a second received cookie having a second received cookie unencrypted portion and a second received cookie encrypted portion;
determining, from the unencrypted portion of the second received cookie, that the freshness timer has expired;
sending a request to a network server for an updated encrypted portion;
receiving the updated encrypted portion;
resetting the freshness timer;
creating a second revised cookie with the updated encrypted portion and reset freshness timer; and
sending the second revised cookie to the web browser.

3. The method of claim 1, wherein the revised cookie includes an updated expiration timer that differs from an expiration timer of the received cookie.

4. The method of claim 1, wherein the freshness timer is shorter than an expiration timer for the received cookie and the revised cookie.

5. The method of claim 1, further comprising storing at the computing device the encrypted portion of the received cookie in unencrypted form.

6. The method of claim 1, wherein the received cookie includes an identification number in the unencrypted portion, and wherein the revised cookie uses the same identification number in its unencrypted portion.

7. The method of claim 2, wherein the received cookie includes a decryption key identifier in the unencrypted portion, and wherein the request to the network server includes the decryption key identifier.

8. The method of claim 1, wherein the encrypted portion of the received cookie includes user profile information.

9. A computing device comprising:
a processor; and
a communication subsystem,
wherein the computing device is configured to:
receive a request from a web browser, the request including a received cookie having an unencrypted portion and an encrypted portion;
determine, from the unencrypted portion of the received cookie, whether a freshness timer has expired;
when the freshness timer has expired:
send a request to a network server for an updated encrypted portion;
receive the updated encrypted portion;
reset the freshness timer;
create a revised cookie with the updated encrypted portion and reset freshness timer; and
send the revised cookie to the web browser; and
when the freshness timer has not expired:
create the revised cookie, the revised cookie using the unencrypted portion and freshness timer from the received cookie; and
send the revised cookie to the web browser.

10. The computing device of claim 9, wherein the revised cookie using the unencrypted portion and freshness timer from the received cookie includes an updated expiration timer that differs from the expiration timer of the received cookie.

11. The computing device of claim 9, wherein the freshness timer is shorter than an expiration timer in any of the received and revised cookies.

12. The computing device of claim 9, wherein the computing device includes a memory for storing the encrypted portion of the received cookie in unencrypted form.

13. The computing device of claim 9, wherein the received cookie includes an identification number in the unencrypted portion, and wherein the revised cookie uses the same identification number in its unencrypted portions.

14. The computing device of claim 9, wherein the received cookie includes a decryption key identifier in the unencrypted portion, and wherein the request to the network server includes the decryption key identifier.

15. The computing device of claim 9, wherein the encrypted portion of the received or revised cookie includes user profile information.

16. A computer readable medium for storing instruction code, which, when executed by a processor of a computing device cause the computing device to:
receive a request from a web browser, the request including a received cookie having an unencrypted portion and an encrypted portion;
determine, from the unencrypted portion of the received cookie, whether a freshness timer has expired;
when the freshness timer has expired:
send a request to a network server for an updated encrypted portion;
receive the updated encrypted portion;
reset the freshness timer;
create a revised cookie with the updated encrypted portion and reset freshness timer; and
send the revised cookie to the web browser; and
when the freshness timer has not expired:
create the revised cookie, the revised cookie using the unencrypted portion and freshness timer from the received cookie; and
send the revised cookie to the web browser.

17. The computer readable medium of claim 16, wherein the revised cookie using the unencrypted portion and the freshness timer from the received cookie includes an updated expiration timer that differs from the expiration timer of the received cookie.

18. The computer readable medium of claim 16, wherein the freshness timer is shorter than an expiration timer in any of the received and revised cookies.

19. The computer readable medium of claim 16, wherein the computing device includes a memory for storing the encrypted portion of the received cookie in unencrypted form.

20. The computer readable medium of claim 16, wherein the received cookie includes an identification number in the unencrypted portion, and wherein the revised cookie uses the same identification number in its unencrypted portions.
